(19) United States
(12) Patent Application Publication
(10) Pub. No.: US 2010/0078928 A1
(43) Pub. Date: Apr. 1, 2010

(54) Page holding device for books with optional stand and reading light

(76) Inventor: Peter Mark Mercieca, Birkirkara (MT)

Correspondence Address: Peter Mark Mercieca, 208/7, Naxcxar Road, Birkirkara, BKR9044, MT

(21) Appl. No.: 12/458,654

(22) Filed: Jul. 20, 2009

Related U.S. Application Data
(60) Provisional application No. 61/129,833, filed on Jul. 23, 2008.

(51) Int. Cl. B42D 9/00

(52) U.S. Cl. 281/42

(57) ABSTRACT

An ultra-compact and lightweight page holding device that keeps a book in open position, which device is adjustable according to book size and has a detachable support attachment and detachable reading light. The page holding device also serves as a bookmarker holding the book firmly closed when in closed position.

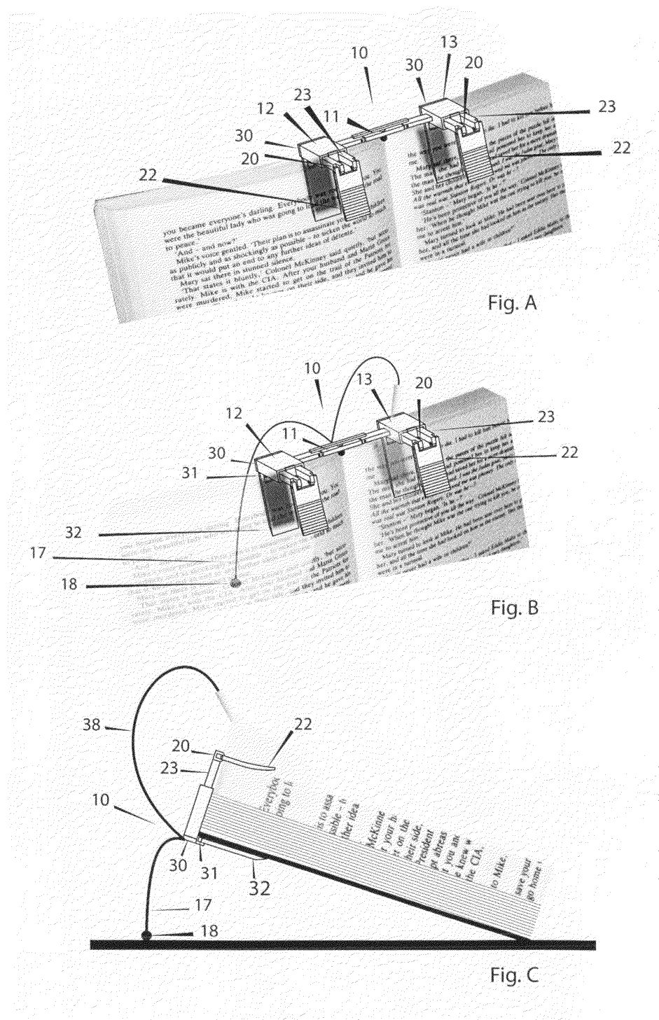

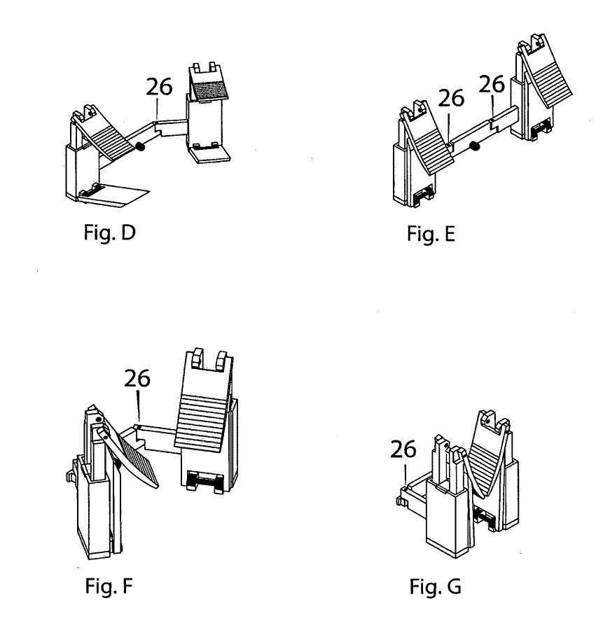

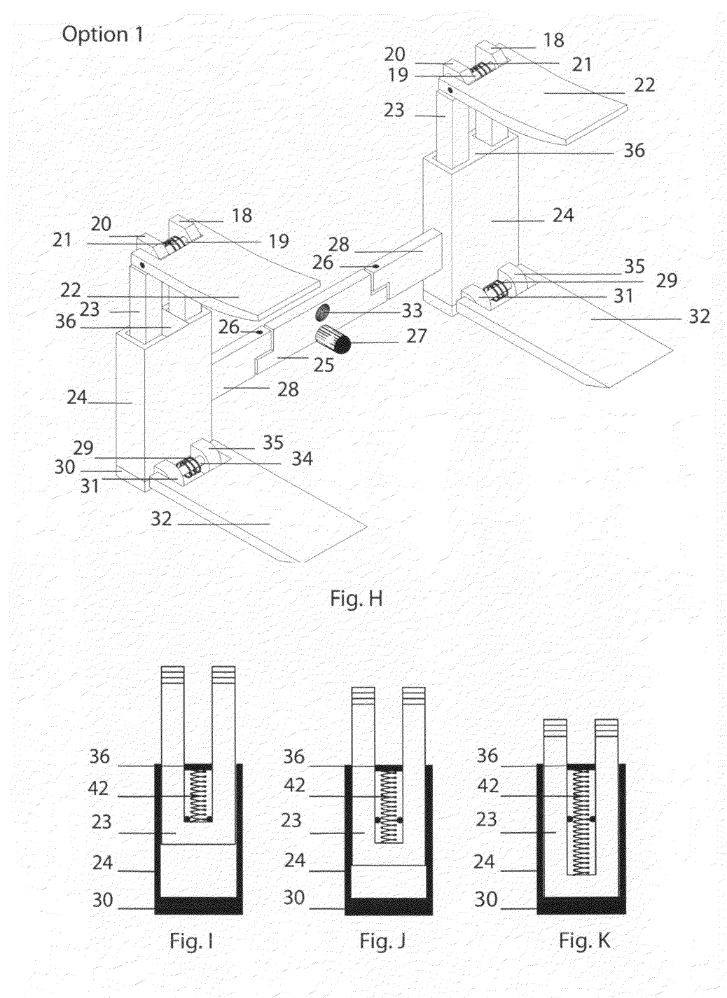

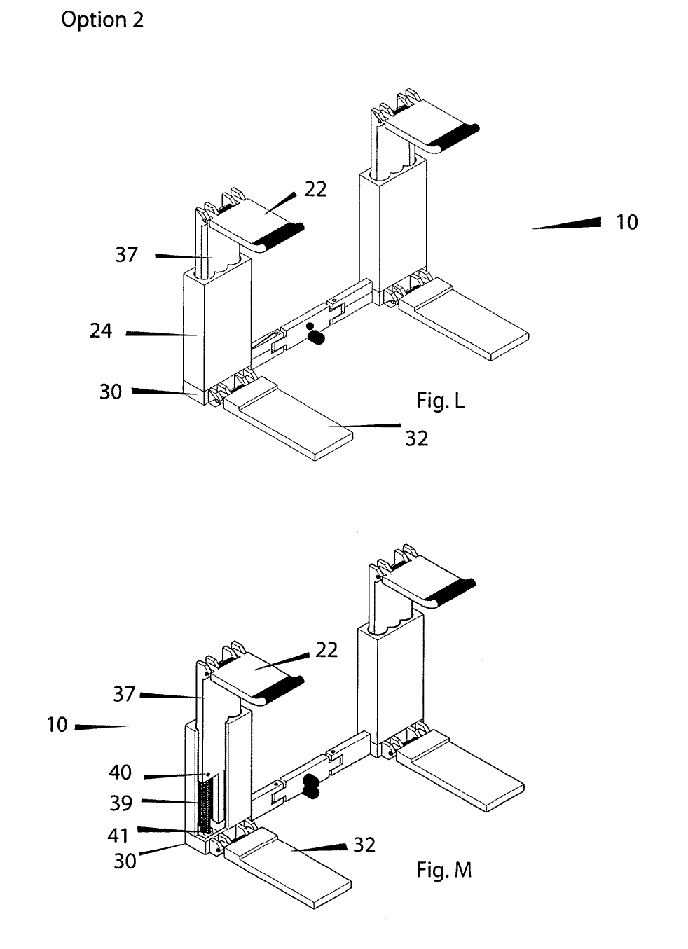

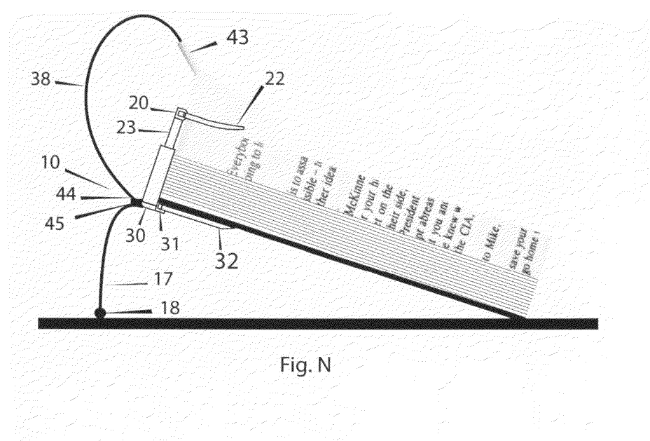

### BACKGROUND TO THE INVENTION

1. Field of Invention

The present invention relates to a page holding device for books and the like (all to be referred to as books throughout), the general object of the invention being to provide a simple, portable and compact device which can be conveniently and effectively employed for holding a book in an open position on any desired page and at the same time permitting the pages to be quickly and easily turned as they are read. With the additional support attachment that may be attached to the connecting rod of the device and removed with ease when not required, the book can be supported and rest on a surface at an angle. An additional reading lamp may be attached to the connecting rod of the page holding device and removed when not required.

2. Description of Related Art

Various products exist in the market and address the problem of holding books open on a specific page. These page holders, however, are often large and designed to rest on tabletops (e.g. US 2007/0131836 A1, PCT WO 2008/008542 A2, PCT WO 2005/011997 A1, US 2008/0001051 A1). There are others that although designed for mobility are still cumbersome and are not fit for travel. Travel page holding devices currently known are still too large and/or heavy to fit comfortably in a pocket (e.g. PCT WO 2007/086791), utilise simplistic methods of keeping a book open at a specific page and therefore either restrict ease of turning pages or do not hold a book open firmly (e.g. US 2007/02571777 A1. Another problem of several compact page holders or book holders is that they are not versatile enough to fit various sizes of books and will only fit comfortably on medium sized books or standard size novels.

What is required is a compact and versatile page holding device that is easy to carry and utilise. A device that holds a book open firmly but contemporaneously permits the pages to be turned easily. All known page holders satisfy one or some requirements mentioned above. However, neither suits all. The present invention satisfies these needs. Furthermore, the present invention adopts a radically different approach to other known portable book holders, such as US 2007/0096002 A1, due to its innovative spring mechanism.

With the additional, optional attachments, which are also extremely compact, this device may be utilised in more scenarios and offers more versatility.

### SUMMARY OF THE INVENTION

A new page holding device is hereby being presented for maintaining a book in an open displayed manner and simultaneously allows pages to be easily turned whilst being read. This new page holding device is more practical, compact, convenient and functional then the ones comprising the prior art. Once the book is closed the device can hold the book firmly closed or serve as a bookmarker.

The device principally employs two u-shaped clips, each having a triple spring mechanism, which clips are attached to each other by a central, flat, double hinged, foldable, connecting bar at the back of the clips. Each clip consists of a back telescopic support that attaches to two members, one at either end. In use, the device is clipped to the top of an open book, each clip holding a side of the book firmly open on the selected page. The central bar serves as a support for the clips and ensures that the book will not close onto itself. The telescopic support compresses the members together and towards each other through the use of compression springs that tighten the telescopic back according to the thickness of the book whilst torsion springs at the base of the members of the clip tighten onto the book covers and respective face of the pages of the book. Thus, holding the book open with a firm, flat and with a balanced grip.

For use with support, the support attachment is screwed into the centre of the connecting bar. Once the page holding device is attached to a book, the book can be placed on a surface. Through the use of the support attachment the open book will comfortably sit on a surface at an angle and unassisted. Thus, enabling the reader to read the book with more ease and comfort.

The device can also be useful to illuminate the pages of a book through the use of the attachable and flexible reading lamp. The lamp is screwed onto the connecting bar and bends over to face the pages of the book illuminating the face of the pages that are held open by the page holding device.

### BRIEF DESCRIPTION OF THE FIGURES

Understanding the invention will be facilitated by referring to the accompanying figures in which like numbers and letters refer to the like parts of the several views and in which:

FIG. A is a perspective view of the page holding device showing it placed at the top of an open book. The telescopic back is extended and the top members are thus not applying pressure to the face of the pages. For ease of comprehending the functionality of the device the book is depicted in a semi transparent manner to expose the back and a bottom members of the clips pressings against the covers of the book.

FIG. B is a similar perspective view. However, FIG. B also comprises the support attachment and the reading lamp and their place of attachment.

FIG. C is a side view of the page holder of FIG. B showing the method of attachment of the page holder onto the book and the manner in which the book is supported by the support attachment. It also comprises the reading light and depict the manner in which the light will illuminate the pages of the book.

FIG. D is a view of the page holding device in a semi-closed position. The connecting bar is also partially closed.

FIG. E is a view of the page holding device having both clips fully closed whilst the connecting bar is in an open position.

FIG. F is a view of the page holding device with the same clips being closed and the connecting bar being partially closed.

FIG. G is a view of the page holding device in a fully closed position.

FIG. H is a perspective of Option 1 of the page holding device in a fully opened position.

FIG. I is a diagram showing the internal mechanism of the telescopic back of one of the clips utilised in Option 1. The back is extended and consequently the spring is compressed. In this method the spring is compressed in order to extend the telescopic arm of the back part of the clip.

FIG. J is a view of the same internal mechanism depicted in FIG. I with the telescopic arm half extended.

FIG. K is a view of the same internal mechanism depicted in FIG. I with the telescopic arm fully closed by the force of the spring.

FIG. L is a perspective of Option 2 of the page holding device in a fully opened position. Option 2 is an alternative method of applying a compression pressure to the telescopic arm. Throughout the description unless stated otherwise reference shall be made to Option 1.

FIG. M is a diagram showing the internal mechanism of the page holding device adopting a different method of extension of the telescopic arm of the back of the clip called Option 2. Instead of compressing the spring in order to extend the telescopic arm this approach adopts a method where the spring is stretched when the telescopic arm is extended.

FIG. N is a side view of the page holding device showing the method of attachment of the page holder onto the book and the manner in which the reading light attaches to the support attachment and bends over the device on order to illuminate the book. It also depicts how the book is held at an angle by the support attachment.

### DETAILED DESCRIPTION OF PREFERRED EMBODIMENT

Reference is first made to FIG. A to FIG. K (both figures included) wherein a page holding device 10 is constructed with the preferred embodiment as shown. The page holding device 10 is designed to hold a book in an open manner, thereby facilitating reading and handling of the book by its user. The lightweight nature of the page holding device 10 enables the user to handle the book with ease and does not cause discomfort. The book is held open when the page holding device 10 is placed onto the top edge of the book. The page holding device 10 thus relieves the user from exerting force on the pages of the book to keep it open. The page holding device 10 fastens to the book through the use of its upper torsion springs 20, lower torsion springs 29 and the compression springs 42. The page holding device 10 could come in different shapes and sizes according to the need. However, the design of the page holding device 10 is such that through the use of the telescopic arms 23, the top members 22 and bottom members 32 the page holding device 10 offers enough flexibility to be utilised on books of most shapes and sizes. This includes books with hard covers, soft covers and other printed publications, for instance novels, catalogues, magazines, brochures, etc.

Referring now to the embodiment of FIGS. A to K, the page holding device 10 includes two clips 12 & 13 held together by a connecting bar 11. The connecting bar 11 is constructed by a central part 25 attached to two side parts 28 by a joint 26 on either side. The central part of the connecting bar 25 has a spherical protrusion 27 that further balances the grip that the page holding device 10 has on the book or other printed reading material. Examples of the material employed for the spherical protrusion 27 include, but are not limited to, rubber and fabric. A screw thread 33 made purposely for the attachment of the support attachment 17 or the reading light 38 is present above the spherical protrusion 27. The clips 12 & 13 and the side parts 28 of the connecting bar 11 are solidly and inflexibly attached together.

Referring now to FIGS. D, E, F and G. The two joints 26 present on the connecting bar 11 only permit a horizontal movement and flexibility of the connecting bar 11. Thus, permitting the page holding device 10 to collapse and close as demonstrated in the depiction of the embodiment in FIG. G. Scope of the vertical rigidity can be understood through FIGS. A & B, whereby in order to keep a book in an open position it is necessary that the connecting bar 11 does not fold vertically.

In the presently preferred embodiment the connecting bar 11 is attached on either side to one of the two clips 12 & 13 at the back of the clip 24 just above the base 30.

A bottom member 32 is attached to the base 30 of the back of the clip 24 by means of a hinges 31 & 35 configured and disposed to pivot about a common pivot point, which in the case of the presently preferred and illustrated embodiment consists of a pivot pin 34 mounted between spaced-apart hinges 31 & 35 projected from the clip base 30 and the bottom member 32. A torsion spring 29 is nested between the bottom member hinges 31 & 35 on the pivot pin 34. One branch of the spring 29 exerts force against the bottom of the bottom member 32 whilst the other branch of the spring 29 exerts force onto the bottom of the base 30. Thus, causing the bottom member 32 to press upwards towards the back of the clip 24. The result is that when a book is placed in the grip of the page holding device 10 the bottom member 32 exerts force onto the cover of the book, pushing it upwards. The pivot pin 34 extends though a hole made in each end.

The top member 22 is attached to the top of the telescopic arm 23 by means of a hinges 18 & 20 configured and disposed to pivot about a common pivot point, which in the case of the presently preferred and illustrated embodiment consists of a pivot pin 19 mounted between spaced apart hinges 18 & 20 at the top of the telescopic arm 23 and at the lower end of the top member 22. A torsion spring 21 is nested between the top member hinges 18 & 20 on the pivot pin 19. One branch of the spring 21 exerts force against the top of the top member 22 whilst the other branch of the spring 21 exerts force onto the outer part of the telescopic arm 23. Thus, causing the top member 22 to press downwards towards the back of the clip 24. The result is that when a book is placed in the grip of the page holding device 10 the top member 22 exerts force onto the page of the book, pushing it downwards. The pivot pin 19 extends though a hole made in each end. Examples of the material employed for the top members 22 include, but are not limited to metal, aluminum and transparent or non-transparent plastic.

Each member 22 & 32 moves independently from the others through the employment of the individual torsion springs 21 & 29. They individually place force onto the respective surface of the book thus balancing the grip that the page holding device 10 has on the book.

Reference is now made to FIG. H. The bottom members 32 are of the same length, shape and size but differ from the top members 22. The top members 22 are slightly bent upwards and get narrower at outer end in order to make turning pages easier once the page holding device is placed onto a book. Unlike the top members 22, the bottom members 32 are flat and of the same width throughout. This permits a steady grip on the cover of the book. It is possible to provide members having different sizes and shape and materials such as rubber may be utilised on the bottom member 32 to permit better grip if desired.

Reference is now being made to FIGS. H, I, J & K, wherein the movement of the telescopic arm 23 can be observed. In this selected embodiment referred to as Option 1 a compression spring 42 is utilised to create a force that pushes the telescopic arm 23 and the top member 22 downwards towards the base 30 of the page holding device 10. The compression spring 42 is nested inside the back of the clip and stabilised by its position between the telescopic arm 23 and the back of the clip 24. The compression spring 42 exerts continuous pressure on both the base of the telescopic arm 23 and 325 the top horizontal flange of the base 36. The result is that the telescopic arm 23 continuously exerts downward pressure towards the base 30.

Reference is now being made to FIGS. L & M. Although the purpose and result is the same as the method employed in Option 1 the method of approach employed to achieve the compression force required for the telescopic arm to assist in the constant spring force exerted on the book is somewhat different. In this method called Option 2, a compression spring is nested inside the back of the clip 24. The top branch of the spring 39 is affixed to the telescopic arm 37 through a hole 40 at its bottom end. The bottom branch of the spring 39 is attached to a hole 41 at the base 30. Once a book is placed between the top member 22 and bottom member 32 the spring is stretched and counters the force with a compression force. The result is that the telescopic arm 37 continuously exerts downward pressure towards the base 30. As a result the telescopic spring mechanism permits the page holding device 10 to be used with books of different thickness.

When a book is present in the page holding device 10, the three forces ensure that the top members 22 press steadily against the pages of the book whilst the bottom members 32 press steadily against the cover of the book. The book will thus be held firmly into position between the top members 22 and the bottom members 32 due to the constant spring force.

The combination between the compression spring 42 and the telescopic arm 23 allow the page holding device 10 to be used with books of different thickness. The constant spring force exerted by the compression spring 42 on the telescopic arm 23 ensures that irrespective of the thickness of the book constant spring force will be exerted by both the top members 22 and the bottom members 32 equally onto the surface of an open book present in the page holding device 10.

Reference is now being made to FIGS. B & C, wherein the support attachment 17 is attached to the page holder device 10. The support attachment 17 is screwed into the back of the page holding device 10 in the apposite screw thread 33 situated in the centre of the central part of the connecting bar 25. The support attachment 17 is held steady by a support attachment base 18 at its lower end. The material employed for the support attachment 17 is flexible but firm enabling the support attachment 17 to be bent according to the reader's need and liking but retaining sufficient rigidity to support the weight of a book. The flexibility of the support attachment 17 also permits easier storage. Examples of the material employed for the support attachment base 18 include, but are not limited to, rubber and fabric.

Reference is now being made to FIG. N, wherein the support attachment 17 and the reading light 38 is attached to the page holder device 10 at the central part of the connecting bar 25 through the apposite screw thread 33.

The support attachment 17 has a screw thread 45 at its top to enable the reading light 38 to be attached to it. Thus, permitting both support attachment 17 and reading light 38 to be utilised contemporaneously.

If it is only desired to utilise the reading light 38 such is directly screwed into the screw thread 33 and bent over the pages of the books. The reading light 38 consists in a flexible neck with one or more Light Emitting Diodes (LED) 43 positioned at its top. The material employed for the neck 44 of the reading light 38 is flexible enabling it to be bent according to the reader's need and liking. The flexibility of the reading light 38 also permits easier storage.

Reference is now made to FIG. H, wherein the top member 22 is slightly bent upwards in order to make turning pages easier once the page holding device is placed onto a book. The top members 22 may be designed in such way that apart from being slightly bent upwards they may get narrower at the outer end in order to further facilitate the turning of pages. Unlike the top members 22, the bottom members 32 are flat and of the same width throughout. This permits a steady grip on the cover of the book.

In use, the page holding device 10 is placed with its open top members 22 and bottom members 32 onto the top of an open book extending the telescopic arm 23 to the desired length to accommodate the thickness of the book. The page holding device 10 is fixed in a manner whereby the top of the spine of the book touches the spherical protrusion 27, the left clip 12 attaches onto the left side of the open book and the right clip 13 attached onto the right side of the open book. Once released the members 22 & 32 assisted by the compression force of the telescopic arm 23 place sufficient pressure onto the book, thus retaining it in an open position. Once in position the pages of the book will be held firm but it will still be possible to change the pages from right to left side and likewise from left to right side.

To insert an open book into the grip of the page holding device 10 the user opens the bottom member 22 and top member 32 of a chosen side of the page holding device 10 whilst extending the telescopic arm 23 as required and slips one side of the open book to the chosen clip 12 or 13. Simultaneously or immediately after the user opens the bottom member 22 and top member 32 of the other side of the page holding device 10 and slips the book in so as to touch the spherical protrusion 27 with the top of the spine of the book.

To turn one of the pages of the open book the user simply slides the page out from under the selected top member 22, turns the page from the first side of the book to the second side thereof and inserts it under the other top member 22. Pages can easily be turned from right to left and likewise from left to right.

To remove and store simply slip the page holding device 10 off from the book and fold in the manner described in FIGS. E, F & G. The spring force applied through the torsion springs 21 & 29 and the compression springs 42 or 39, depending on the Option employed, closes the two clips 12 & 13 onto themselves. The page holding device 10 is then simply folded in the manner described in FIGS. F & G.

Although the invention has been described with reference to particular preferred embodiments, many changes and modifications will become apparent to those skilled in the art in view of the foregoing description which is intended to be illustrative and not limiting of the invention defined in the claims. The device and the several different parts employed in the device can be manufactured from plastic, rubber, steel, aluminum and/or other alloy or such materials. It must be understood that these claims are intended to cover all of the generic and specific features of the page holding device 10 herein described. In fact the text provides mere examples of some of the possible equivalents, sub-combinations of elements and additional features. Others are possible and it should be understood that the claims are intended to cover all of the generic and specific features and elements of the book holder herein described.

It is also to be understood the following claims are intended to cover all of the generic and specific features of the invention herein described and all statements of the scope of the invention.

What is claimed is:

1. An ultra compact page holding device for holding books in an open display manner, the page holder comprising:
a horizontal connecting bar that connects to two u-shaped clips on either end of the bar;
each u-shaped clip composed of a vertical back support that pivotally attaches to a restraining member on either end which members individually exert force onto the respective surfaces of a book; and
page restraining means for restraining the pages of a book wherein the collective force of restraining members exert a uniform and balanced restraining force thus holding the book in an open position.

2. The page holding device according to claim 1, further comprising top members that are slightly bent upwards and get narrower towards the outer end in order to facilitate the turning of pages.

3. The page holding device according to claim 1, further comprising top members that are slightly bent upwards and get narrower towards the outer end and further are transparent in order to render visible any printed matter that may otherwise be concealed under the members.

4. The page holding device according to claim 1, wherein the bottom members are flat and of the same width throughout, thus providing a steady grip on the book cover.

5. The page holding device according to claim 1, wherein the bottom members are flat and of the same width throughout and further comprise a grip surface for better grip.

6. The page holding device according to claim 1, wherein the top and bottom members are connected to the back of the u-shaped clips by means of pivot pins mounted between spaced-apart hinges.

7. The page holding device according to claim 1, wherein the top and bottom members are connected to the back of the u-shaped clips by means of a pivot pin mounted between spaced-apart hinges and further comprising a torsion spring nested on each respective pivot pin which springs exert force on the their respective members and are continuously pushing towards each other.

8. An ultra compact page holding device for holding books in an open display manner, the page holder comprising:
a connecting bar of vertical rigidity that connects to the u-shaped clips on either end of the bar which rigidity ensures that the device holds a book in an open position whilst being horizontally foldable in order to allow for compact storage of the device;
each u-shaped clip composed of a vertical back support that pivotally attaches to a restraining member on either end which members individually exert force onto the respective surfaces of a book; and
page restraining means for restraining the pages of a book wherein the collective force of restraining members exert a uniform and balanced restraining force and the rigidity of the connecting bar prevents the book from closing and the pages from turning.

9. The page holding device according to claim 8, further comprising a connecting bar consisting of three short parts pivotally attached to each other.

10. The page holding device according to claim 8, wherein the connecting bar consists of three parts pivotally attached to each other and the central part comprises a screw thread for the attachment of accessories.

11. The page holding device according to claim 8, wherein the connecting bar consists of three parts pivotally attached to each other, the central part comprises a spherical protrusion that assists in further securing the restraint of the page holding device onto a book.

12. The page holding device according to claim 8, wherein the connecting bar consists of three parts pivotally attached to each other, the central part comprises a screw thread for the attachment of accessories and a spherical protrusion assists in further securing the restraint of the page holding device onto a book.

13. The page holding device as claimed in claim 8, further comprising a flexible support attachment attached to the page holding device from the screw thread situated in the centre of the central part of the connecting bar.

14. The page holding device as claimed in claim 8, further comprising an LED reading light attachment with flexible neck attached to the page holding device from screw thread situated in the centre of the central part of the connecting bar.

15. A page holding device as claimed in claim 8, further comprising a flexible support attachment attached to the page holding device from screw thread situated in the centre of the central part of the connecting bar and an LED reading light attachment with flexible neck attached to the support attachment from a screw thread situated at the top of the support attachment.

16. An ultra compact page holding device for holding books in an open display manner, the page holder comprising:
a connecting bar of vertical rigidity that connects to the u-shaped clips on either end of the bar which rigidity ensures that the device holds a book in an open position whilst being horizontally foldable in order to allow for compact storage of the device;
each u-shaped clip composed of a vertical back support that pivotally attaches to a restraining member on either end which members individually exert force onto the respective surfaces of a book;
page restraining means for restraining the pages of a book wherein the said back of the individual u-shaped clips consist of 2 members that are telescopically integrated so that the back of the clips can adjust to accommodate a variety of thicknesses of books; and
page restraining means for restraining the pages of a book wherein the collective force of restraining members, the compression force of the telescopic arms together with and the rigidity of the connecting bar collectively exert a uniform and balanced restraining force which prevents the book from closing and the pages from turning.

17. The page holding device according to claim 16 comprising a compression spring nested inside the back of each clip which spring creates the restraining force of the telescopic back of the respective clip and exerts continuous expansion pressure by pushing the inner part of the telescopic arm inwards.

18. The page holding device according to claim 16 comprising a compression spring nested inside the back of each clip which spring creates the restraining force of the telescopic back of the respective clip by pulling the internal part of the telescopic back inwards towards the base of the u-shaped clip.
